(19) United States
(12) Patent Application Publication
(10) Pub. No.: US 2005/0099811 A1
(43) Pub. Date: May 12, 2005

(54) Trigonal decorative light string

(76) Inventor: Hung-Huei Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,617

(22) Filed: Nov. 12, 2003

(51) Int. Cl. F21V 21/00

(52) U.S. Cl. 362/252; 362/249; 362/806

(57) ABSTRACT

The invention relates to a trigonal decorative light string, which includes a main electrical wire connecting with a net-type string. The bottom bulbs of the net-type string are connecting with a relating linear branch string having different length that will figures a trigonal structure of the complete string and obtains a unique decorative effect.

### BACKGROUND OF THE INVENTION

A light string is popular for decoration. The light string is also designed to be a certain-type string or a net-type string for improving lighting effect. But each conventional light string provides a single lighting effect that is not enough for requirement in these newly days.

Accordingly, the present invention is to provide a trigonal decorative light string, which has characters of both a certain-type string and a net-type string and provides a better trigonal-type structure for perfect lighting purpose. Now, the present invention will be described as following accompanying with enclosed drawings.

### BRIEF DESCRIPTION OF THE DRAWINGS

FIG. 1 is a plan view showing a trigonal light string according to the present invention.

FIG. 2 is a plan view showing another embodiment having two similar strings in connection according to the present invention.

### DETAILED DESCRIPTION OF THE PREFERRED EMBODIMENT

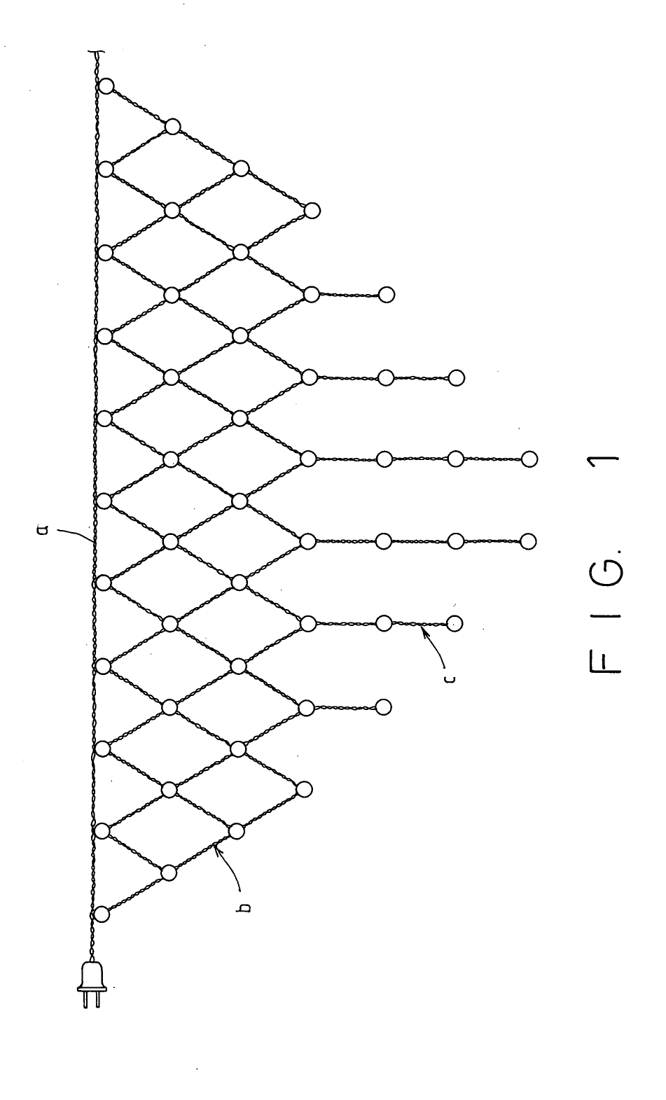

Please referring to FIG. 1, the present invention is to provide a trigonal decorative light string as a decorative lighting unit, which includes a main electrical wire (a) connecting with a net-type string (b). The string will be figured to be a trigonal shape when several linear branch strings (c) having different length are connected to relating bulbs at the bottom of the net-type string (b). In detail, a longest linear string (c) is connected with the bulb at central position among all bottom bulbs of the net-type string (b), while the shorter one is connected beside and so on. Hence, the present invention is unique and has double decorative effects of net-type string and certain-type string.

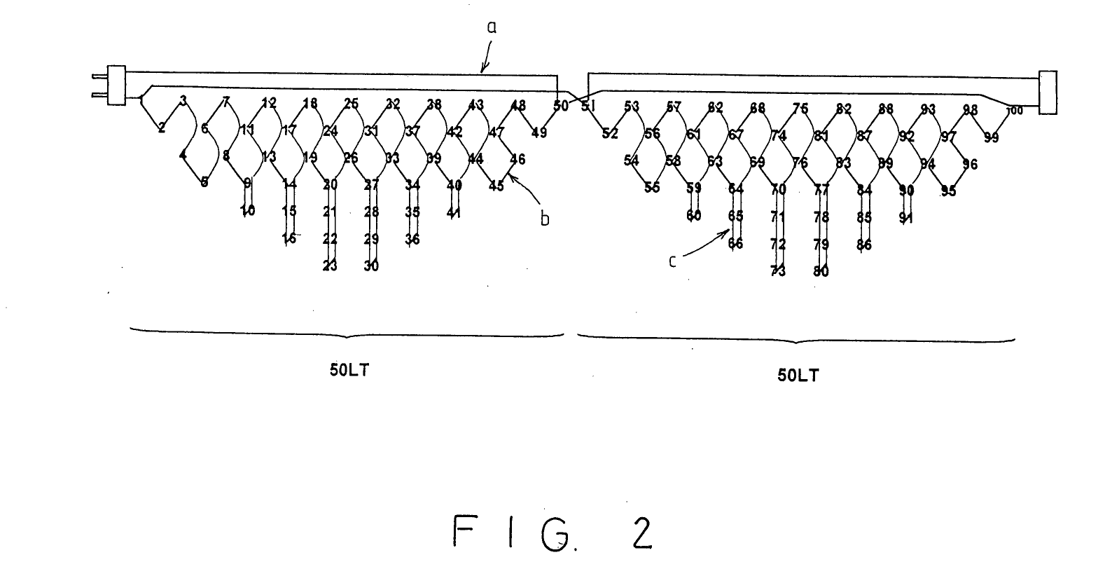

In further application, two or more units of the trigonal light string can be connected together for increasing the decoration, such as shown in FIG. 2. It includes bulb assemblies (1) to (100) and will provide a better lighting effect for decoration. A third unit is possible to be used for a further improvement.

1. A trigonal decorative light string including a main electrical wire connecting with a net-type string while the bottom bulbs of the net-type string are connecting with a relating linear branch string having different length for figuring a trigonal structure of the complete string.

2. A trigonal decorative light string as claimed in claim 1, wherein two or more trigonal light strings are capable of being connected together to form a combination of decoration.
